(19) United States
(12) Patent Application Publication
(10) Pub. No.: US 2004/0022064 A1
(43) Pub. Date: Feb. 5, 2004

(54) Lamp for the rear-view mirror of a vehicle

(76) Inventor: Fang-Mei Kuo, Yung Kang (TW)

Correspondence Address: Alan D. Kamrath, Rider, Bennett, Egan & Arundel, LLP, Suite 2000, 333 South Seventh Street, Minneapolis, MN, 55402, US

(21) Appl. No.: 10/209,852

(22) Filed: Jul. 31, 2002

(51) Int. Cl. B60R 1/12

(52) U.S. Cl. 362/494

(57) ABSTRACT

A lamp for the rearview mirror of a vehicle includes a transparent lamp shade fitted in the through hole bored in the outer wall of a rearview mirror shell, a lamp installed in the inner hollow of the transparent lamp shade and a support member screwed together with the transparent lamp shade. Any rearview mirror shells of different shapes can be bored with a through hole of an identical diameter for the transparent lampshade and the lamp to be fitted therein. Besides, the transparent lampshade and the support member are respectively formed with a threaded portion to be screwed together and be firmly assembled with the rearview mirror shell, regardless of thickness of the rearview mirror shell.

### BACKGROUND OF THE INVENTION

This invention relates to a lamp for the rearview mirror of a vehicle, particularly to one easy to be firmly assembled with a rearview mirror for warning to avoid accidents of vehicle collision.

Generally, a lamp assembled with a rearview mirror of a vehicle is for the sake of safety, especially when driving in bad weather or at night. A rearview mirror with a lamp has been researched and developed in recent years, but to produce such a product, a new mold has to be made for injection molding, thus increasing producing cost and leaving those old molds becoming useless. Old molds for producing rearview mirror shells are available in this invention through a simple processing.

### SUMMARY OF THE INVENTION

The objective of the invention is to offer a lamp for the rearview mirror of a vehicle, which is installed within the inner hollow of a transparent lamp shade positioned in a through hole bored in the outer wall of a rearview mirror shell, with the transparent lamp shade screwed together with a support member to let the lamp firmly positioned in the rearview mirror shell. Under this condition, old molds for producing rearview mirror shells can be processed and employed in this invention to economize producing cost. The method is to have a rearview mirror shell bored with a through hole in the outer wall for receiving different shapes of transparent lamp shade and lamp, with the transparent lamp shade and the support member respectively formed with a threaded portion for facilitating installing the lamp, regardless of thickness of the rearview mirror shell, ensuring safety when driving in bad weather or at night.

### BRIEF DESCRIPTION OF DRAWINGS

This invention will be better understood by referring to the accompanying drawings, wherein:

FIG. 1 is an exploded perspective view of a lamp unit in the present invention:

FIG. 2 is a perspective view of the lamp unit assembled with a rearview mirror shell in the present invention:

FIG. 3 is a front view of a transparent lampshade assembled with the rearview mirror shell in the present invention:

FIG. 4 is a side-sectional view of the lamp unit assembled with the rearview mirror shell in the present invention:

FIG. 5 is a side-sectional view of another type of lamp unit assembled with the sideview mirror shell in the present invention:

FIG. 6 is a front view of a second type of a transparent lampshade assembled with the sideview mirror shell in the present invention: and

FIG. 7 is a front view of a third type of a transparent lampshade assembled with the sideview mirror shell in the present invention.

### DETAILED DESCRIPTION OF THE PREFERRED EMBODIMENT

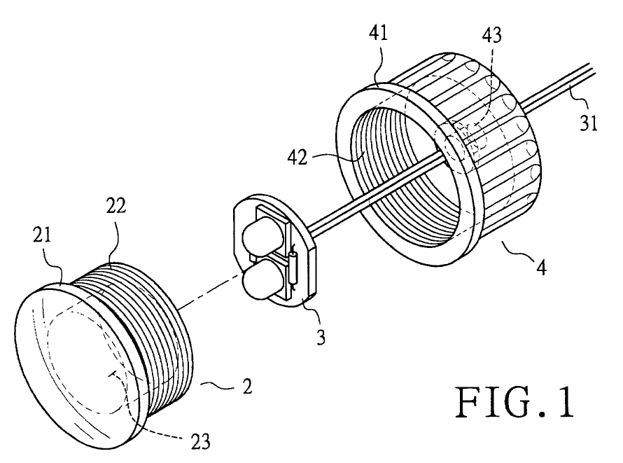

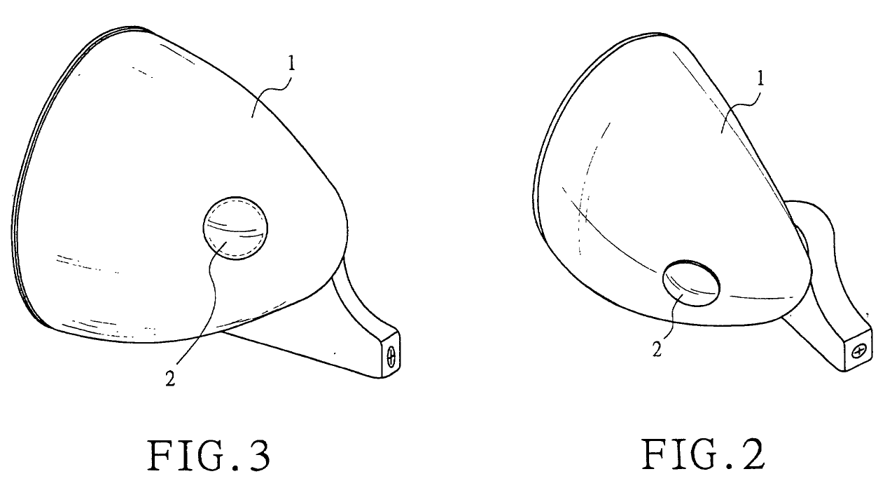

A preferred embodiment of a lamp for the rearview mirror of a vehicle in the present invention, as shown in FIGS. 1, 2 and 3, includes a rearview mirror shell 1, a transparent lampshade 2, a lamp 3 and a support member 4 combined together.

The rearview mirror shell 1 is bored with a through hole 11 at a proper location of its outer wall.

The transparent lamp shade 2 has one end formed with an annular prop portion 21 protruding outward, the other end extending outward to make up an outer threaded portion 22, and an inner hollow 23.

The lamp 3, a common lamp or a LED, has an electric wire 31 extending backward to be connected with a switch in a vehicle for the convenience of turning on and off.

The support member 4 has one end formed with an annular contact portion 41 protruding outward, an inner annular female-threaded portion 42 engaging with the outer male-threaded portion 22 of the transparent lamp shade 2, and the other end bored with a through hole 43 in the center.

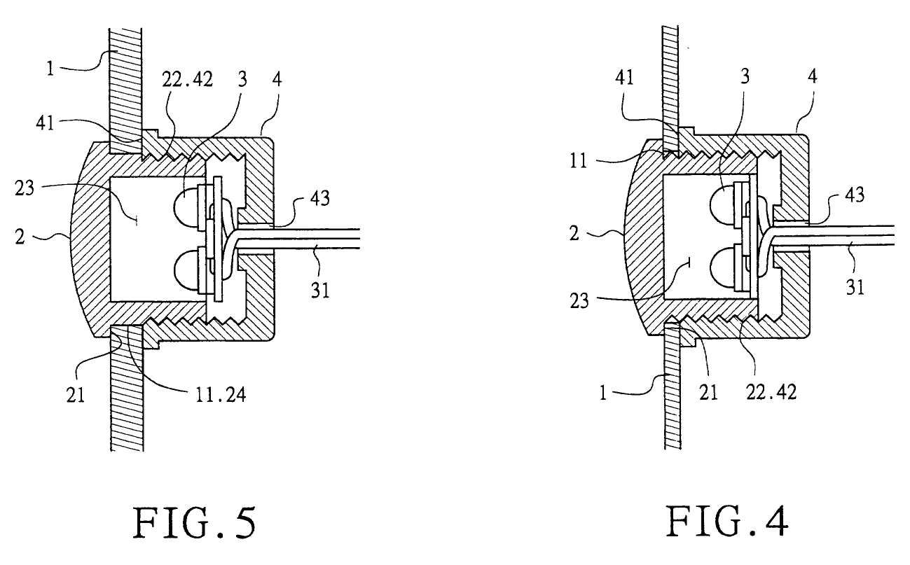

In assembling, as shown in FIGS. 4 and 5, the transparent lamp shade 2 has its outer male-threaded portion 22 inserted backward in the through hole 11 of the rearview mirror shell 1, letting its prop portion 21 closely rest against the outer wall of the rearview mirror shell 1. Next, the lamp 3 is positioned in the inner hollow 23 of the transparent lamp shade 2, having its electric wire 31 inserted through the through hole 43 of the support member 4. Then, the support member 4 has its inner annular female-threaded portion 42 engaged with the outer threaded portion 22 of the transparent lamp shade 2, letting the contact portion 41 of the support member 4 closely rest against the inner wall of the rearview mirror shell 1. Thus, the lamp 3 can be firmly and smoothly installed in the through hole of the rearview mirror shell 1, regardless of thickness and profile of the sideview mirror shell.

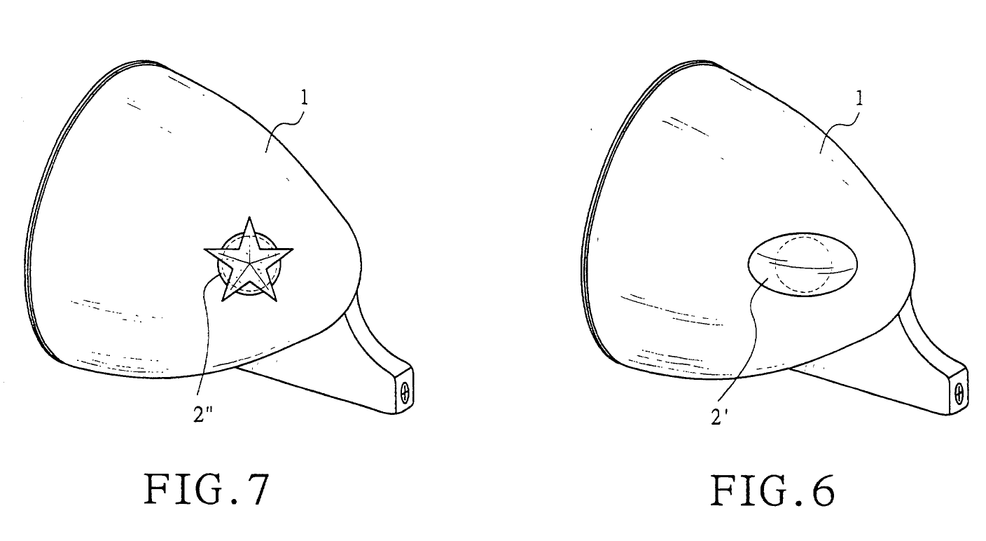

Further, the outer male-threaded portion 22 of the transparent lamp shade 2 can be entirely formed into threads, as shown in FIG. 4, or partly formed into a smooth surface 24, as shown in FIG. 5. Furthermore, the prop portion 21 of the transparent lampshade 2, which rests against the outer wall of the rearview mirror shell 1, can be variously shaped, as shown in FIGS. 6 and 7.

While the preferred embodiment of the invention has been described above, it will be recognized and understood that various modifications may be made therein and the appended claims are intended to cover all such modifications that may fall within the spirit and scope of the invention.

I claim

1. A lamp for the rearview mirror of a vehicle comprising a transparent lampshade, a lamp and a support member: and
Characterized by said transparent lamp shade having its front end formed into an annular prop portion and its rear end formed into an outer threaded portion, said transparent lamp shade formed with an inner hollow: and
Said support member having its front end formed into an annular contact portion, said contact portion having a hollow interior, said hollow interior provided with an inner annular female-threaded portion, said transparent lamp shade having said outer threaded portion screwed together with said inner annular female-threaded portion of said support member, said annular prop portion of said transparent lamp shade resting closely on the outer wall of said rearview mirror shell.

2. The lamp for the rearview mirror of a vehicle as claimed in claim 1, wherein said prop portion of said transparent lampshade is variously shaped.

3. The lamp for the rearview mirror of a vehicle as claimed in claim 1, wherein said transparent lampshade has its outer circumferential surface partly formed into a smooth-surface and partly a male-threaded portion.
